(19) United States
(12) Patent Application Publication
(10) Pub. No.: US 2006/0286381 A1
(43) Pub. Date: Dec. 21, 2006

(54) Antireflection film for plasma display

(76) Inventors: Nobuo Naito, Tokyo (JP); Fumihiro Arakawa, Tokyo-To (JP); Tadahiro Masaki, Tokyo-To (JP)

Correspondence Address: OLIFF & BERRIDGE, PLC, P.O. BOX 19928, ALEXANDRIA, VA, 22320, US

(21) Appl. No.: 10/569,492

(22) PCT Filed: Aug. 30, 2004
(86) PCT No.: PCT/JP04/12490

§ 371 Date: Feb. 27, 2006

(30) Foreign Application Priority Data
Sep. 1, 2003 (JP) 2003-308739

(51) Int. Cl. B32B 27/20

(52) U.S. Cl. 428/411.1

(57) ABSTRACT

An anti-reflection layer 51 is provided on one surface of a transparent substrate film 31. A specific-wavelength-light shielding layer 39 containing a coloring agent for color tone correction capable of absorbing light with specific wavelengths originating from the emission spectrum of an insert gas of a PDP, and/or a near infrared rays absorbing agent, is provided on the other surface of the transparent substrate film 31. Further, a pressure-sensitive adhesive layer 41 is optionally provided on the specific-wavelength-light shielding layer 39.

### FIELD OF THE INVENTION

The present invention relates to an anti-reflection film for a plasma display, and, more particularly, to an anti-reflection film for a plasma display that is placed on the front of a plasma display element (also referred to as a PDP) so as to shield near infrared rays that are emitted from the element and also to prevent reflection of extraneous light from the screen of the element, thereby making an image displayed on a display (also referred to as an image display) highly visible.

### BACKGROUND ART

In this Specification, “ratio”, “part”, “%”, and the like that indicate proportions are on a weight basis unless otherwise specified, and the symbol “/” denotes that layers enumerated together with it are integrally laminated. Further, “PDP” designates a “plasma display element”; “NIR”, near infrared rays”; “EMI”, “electromagnetic waves”; and “PET”, “polyethylene terephthalate”. Furthermore, the word “anti-reflection (or preventing reflection of (extraneous) light)” denotes the function of preventing reflection of light in which reflected light is attenuated by multilayer film interference and/or the function of cutting glare in which light components reflected by specular reflection are reduced by diffuse reflection.

1. Background of the Invention

A PDP is composed of a glass substrate having a data electrode and a fluorescent layer and a glass substrate having a transparent electrode, a gas such as xenon or neon being sealed in a space between the two glass substrates. PDPs can be made large in screen size as compared with conventional cathode ray tubes (CRTs) and have come to be used widely. It is necessary to treat the screens of PDPs so that the reflection of extraneous light such as sunlight from the screens is reduced. In operation, a PDP produces large amounts of electromagnetic waves, near infrared rays, and unwanted light with specific wavelengths originating from the emission spectrum of an insert gas. In order to shield or reduce these electromagnetic waves, near infrared rays, and unwanted light with specific wavelengths, a front panel for plasma display (composite filter) produced by laminating a near infrared rays absorbing film, an unwanted light absorbing film, and an anti-reflection film together with an adhesive layer is mounted on the front of a PDP, whereby a plasma display is constructed.

The anti-reflection film for a plasma display, a constituent of the front panel for a plasma display, is required to have, in addition to moderate transparency (visible light transmittance) and luminance, the function of imparting the property of preventing reflection of extraneous light and the anti-glare properties to a display so that an image displayed on the display can be seen with higher visibility. Further, the anti-reflection film is also required to shield near infrared rays with wavelengths of 900 to 1,100 nm, emitted from a PDP, because these rays cause malfunction of remote controllers for VTRs and the like. Furthermore, it is also necessary to correct the inherent emission spectrum of an insert gas characteristic of a PDP, or to adjust the color tone of an image to a favorite one, thereby optimizing the color quality to improve image quality. Moreover, it is required for the anti-reflection film for a plasma display that the film, together with optional layers such as an electromagnetic wave (EMI) shielding film and a substrate having mechanical strength high enough to prevent damage that is caused by external force, can easily form a front panel for plasma display.

2. Related Art

There have so far been known optical display filters using dyes capable of shielding near infrared rays (see Patent Documents 1 and 2, for example). Since dyes are incorporated in the substrates of the optical display filters disclosed in these publications, these filters are disadvantageous in that their production processes demand the step of incorporating dyes and also facilities and materials that are used in this step, which leads to increase in cost. There have also been known optical display filters that are obtained by laminating an electromagnetic wave shielding layer and an anti-reflection layer together with an adhesive (pressure-sensitive adhesive) layer or the like, a near infrared rays absorbing agent and a dye that absorbs light with specific wavelengths being incorporated in these layers (see Patent Documents 3 to 5, for example). These publications describe the incorporation of dyes, but none of them specifically describes nor suggests layers in which the dyes should be incorporated. There has also been known a composite filter that is a laminate of an anti-reflection film, a near infrared rays absorbing film, and an electromagnetic wave shielding film, laminated together with an adhesive layer (see Patent Document 6, for example).

Patent Document 1: Japanese Laid-Open Patent Publication No. 137442/2000;

Patent Document 2: Japanese Laid-Open Patent Publication No. 186127/1998;

Patent Document 3: Japanese Laid-Open Patent Publication No. 15533/2003;

Patent Document 4: Japanese Laid-Open Patent Publication No. 15536/2003;

Patent Document 5: Japanese Laid-Open Patent Publication No. 311843/2002; and

Patent Document 6: Japanese Laid-Open Patent Publication No. 126024/1999.

### DISCLOSURE OF THE INVENTION

The present invention was accomplished in order to solve the aforementioned problems in the prior art. An object of the present invention is to make it possible to shield unwanted light emitted from a PDP and also to impart, to the PDP, the property of preventing reflection of light by laminating one film to the PDP. Namely, an object of the present invention is to provide, in a minimum number of lamination steps, a durable anti-reflection film for a plasma display having the property of shielding near infrared rays and/or unwanted light with specific wavelengths originating from the emission spectrum of an insert gas, capable of imparting, to a plasma display, the property of preventing reflection of extraneous light, thereby making the plasma display satisfactorily reproduce natural color, provide improved image visibility, cause no malfunction of remote controllers that is usually caused by near infrared rays, and stably maintain the image visibility for a prolonged period of time.

The present invention is an anti-reflection film for a plasma display, comprising a transparent substrate film, an anti-reflection layer provided on one surface of the transparent substrate film, and an unwanted light shielding layer provided on the other surface of the transparent substrate film, the unwanted light shielding layer containing a transparent resin and a coloring agent for color tone correction that absorbs light with specific wavelengths originating from the emission spectrum of an insert gas of a plasma display and/or a near infrared rays absorbing agent that absorbs near infrared rays, contained in the transparent resin.

The present invention is the above-described anti-reflection film for a plasma display, wherein the transparent resin contains a coloring agent for color tone adjustment.

The present invention is the above-described anti-reflection film for a plasma display, further comprising a pressure-sensitive adhesive layer that is laminated to the unwanted light shielding layer.

The present invention is an anti-reflection film for a plasma display, comprising a transparent substrate film, an anti-reflection layer provided on one surface of the transparent substrate film, and an unwanted light shielding layer provided on the other surface of the transparent substrate film, the unwanted light shielding layer comprising a near infrared rays absorbing layer containing a transparent resin and a near infrared rays absorbing agent that absorbs near infrared rays, contained in the transparent resin, and a specific-wavelength-light absorbing layer laminated to the near infrared rays absorbing layer on the side opposite to the transparent substrate film, containing a pressure-sensitive adhesive and a coloring agent for color tone correction that absorbs light with specific wavelengths originating from the emission spectrum of an insert gas of a plasma display, contained in the pressure-sensitive adhesive.

The present invention is the above-described anti-reflection film for a plasma display, wherein the pressure-sensitive adhesive contains a coloring agent for color tone adjustment.

The present invention is an anti-reflection film for a plasma display, comprising a transparent substrate film, an anti-reflection layer provided on one surface of the transparent substrate film, and an unwanted light shielding layer provided on the other surface of the transparent substrate film, the unwanted light shielding layer comprising a near infrared rays reflecting layer made of a metallic film that reflects near infrared rays, and a specific-wavelength-light absorbing layer laminated to the near infrared rays reflecting layer on the side opposite to the transparent substrate film, containing a pressure-sensitive adhesive and a coloring agent for color tone correction that absorbs light with specific wavelengths originating from the emission spectrum of an insert gas of a plasma display, contained in the pressure-sensitive adhesive.

The present invention is the above-described anti-reflection film for a plasma display, wherein the pressure-sensitive adhesive contains a coloring agent for color tone adjustment.

The present invention is an anti-reflection film for a plasma display, comprising a transparent substrate film, an anti-reflection layer provided on one surface of the transparent substrate film, and an unwanted light shielding layer provided on the other surface of the transparent substrate film, the unwanted light shielding layer containing a pressure-sensitive adhesive and a coloring agent for color tone correction that absorbs light with specific wavelengths originating from the emission spectrum of an insert gas of a plasma display and/or a near infrared rays absorbing agent that absorbs near infrared rays, contained in the pressure-sensitive adhesive.

The present invention is the above-described anti-reflection film for plasma display, wherein the pressure-sensitive adhesive contains a coloring agent for color tone adjustment.

The present invention is an anti-reflection film for a plasma display, comprising a transparent substrate film, an anti-reflection layer provided on one surface of the transparent substrate film, and an unwanted light shielding layer provided on the other surface of the transparent substrate film, the unwanted light shielding layer comprising a specific-wavelength-light absorbing layer containing a transparent resin and a coloring agent for color tone correction that absorbs light with specific wavelengths originating from the emission spectrum of an insert gas of a plasma display, contained in the transparent resin, and a near infrared rays absorbing layer laminated to the specific-wavelength-light absorbing layer on the side opposite to the transparent substrate film, containing a pressure-sensitive adhesive and a near infrared rays absorbing agent that absorbs near infrared rays, contained in the pressure-sensitive adhesive.

The present invention is the above-described anti-reflection film for a plasma display, wherein the transparent resin contains a coloring agent for color tone adjustment.

The present invention is the above-described anti-reflection film for a plasma display, wherein at least one layer selected from the transparent substrate film and the layers provided on the transparent substrate film on the side opposite to the unwanted light shielding layer contains an ultraviolet light absorber.

The present invention provides an anti-reflection film for plasma display that has moderate transparency and luminance and the property of preventing reflection of light, can shield near infrared rays with wavelengths of 800 to 1,100 nm, and can optimize the color quality to improve image quality by correcting the inherent emission spectrum of an insert gas characteristic of a PDP and adjusting the color tone of a displayed image to a favorite one.

The present invention provides an anti-reflection film for plasma display that can form, together with other layers such as an electromagnetic wave shielding film and a substrate, a front panel for a plasma display with ease.

According to the present invention, since a coloring agent for absorbing near infrared rays and a coloring agent for absorbing light with specific wavelengths originating from the emission spectrum of an insert gas are incorporated in different layers, it is easy to control only the coloring agent for color tone correction that requires the adjustment of transmittance, and there is provided an anti-reflection film for plasma display that can stably maintain the visibility of a displayed image for a long period of time.

The present invention provides an anti-reflection film for a plasma display that has the function of shielding near infrared rays and electromagnetic waves.

According to the present invention, since an anti-reflection layer, a near infrared rays absorbing layer, and a specific-wavelength-light absorbing layer are integrally formed in advance, the number of layers to be laminated is small, and, moreover, a front panel for a plasma display can be produced in a decreased number of steps; there is thus provided an inexpensive anti-reflection film for a plasma display.

According to the present invention, since an ultraviolet light absorber is incorporated in at least one layer selected from the transparent substrate film and the layers provided on the transparent substrate film on the side opposite to the unwanted light shielding layer (external side), there is provided a light-fast anti-reflection film for plasma display in which the coloring agent contained in the unwanted light shielding layer does not undergo deterioration by ultraviolet light contained in extraneous light such as sunlight and neither loses its ability to absorb near infrared rays nor undergoes change in color such as yellowing.

### BRIEF DESCRIPTION OF THE DRAWINGS

FIG. 1 is a cross-sectional view of an anti-reflection film for a plasma display, one embodiment of the present invention,

FIG. 2 is a cross-sectional view of an anti-reflection film for a plasma display, another embodiment of the present invention, and

FIG. 3 is a cross-sectional view of an anti-reflection film for a plasma display, a further embodiment of the present invention.

### BEST MODE FOR CARRYING OUT THE INVENTION

Embodiments of the present invention will be described hereinafter in detail with reference to the accompanying drawings.

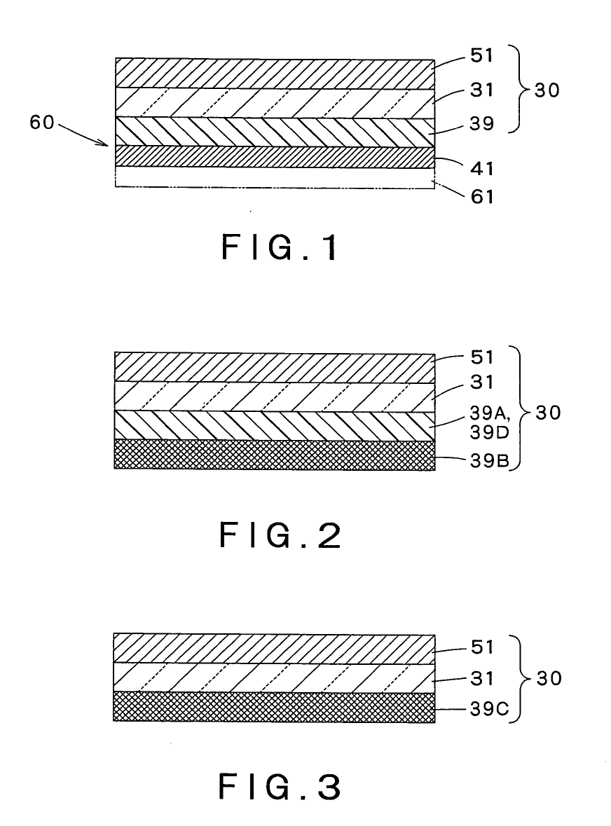

FIG. 1 is a cross-sectional view of an anti-reflection film for a plasma display, one embodiment of the present invention.

FIG. 2 is a cross-sectional view of an anti-reflection film for a plasma display, another embodiment of the present invention.

FIG. 3 is a cross-sectional view of an anti-reflection film for a plasma display, a further embodiment of the present invention.

(Basic Construction)

As shown in FIG. 1, an anti-reflection film for a plasma display 30 of the present invention comprises an anti-reflection layer 51/a transparent substrate film 31/an unwanted light shielding layer 39. Namely, the anti-reflection film for plasma display 30 comprises the transparent substrate film 31, the anti-reflection layer 51 provided on one surface of the transparent substrate film 31, and the unwanted light shielding layer 39 provided on the other surface of the transparent substrate film 31. Further, as shown in FIG. 1, a pressure-sensitive adhesive layer 41 may be laminated to the unwanted light shielding layer 39. Specifically, in FIG. 1, a near infrared rays absorbing agent and/or a coloring agent for color tone correction is incorporated in the unwanted light shielding layer 39.

Further, as shown in FIG. 2, an anti-reflection film for a plasma display 30 may comprise an anti-reflection layer 51/a transparent substrate film 31/a near infrared rays absorbing layer 39A/a specific-wavelength-light absorbing layer 39B, where a near infrared rays absorbing agent and a coloring agent for color tone correction are incorporated in the near infrared rays absorbing layer 39A and the specific-wavelength-light absorbing layer 38B, respectively. Alternatively, a near infrared rays reflecting layer 39D composed of a metallic film may be used in place of the near infrared rays absorbing layer 39A. In this anti-reflection film, the near infrared rays absorbing layer 39A and the specific-wavelength-light absorbing layer 39B, or the near infrared rays reflecting layer 39D and the specific-wavelength-light absorbing layer 39B constitute the unwanted light shielding layer 39.

Furthermore, as shown in FIG. 3, an anti-reflection film for a plasma display 30 may comprise an anti-reflection layer 51/a transparent substrate film 31/an unwanted light shielding layer 39C, where a near infrared rays absorbing agent and/or a coloring agent for color tone correction is incorporated in the unwanted light shielding layer 39C.

A coloring agent for color tone adjustment may further be incorporated in the unwanted light shielding layer 39, the specific-wavelength-light absorbing layer 39B, or the unwanted light shielding layer 39C that contains the coloring agent for color tone correction.

Moreover, in the anti-reflection films shown in FIGS. 1 to 3, a hard coat layer is preferably provided between the transparent substrate film 31 and the anti-reflection layer 51. Alternatively, the anti-reflection layer 51 may include a hard coat layer as its constituent layer.

The anti-reflection film for a plasma display 30 of the present invention combined with other members such as an electromagnetic wave shielding film for a plasma display and/or a protective plate serves as a front panel for a plasma display when placed on the observation side of a PDP, and can show the required functions.

(Definitions of Coloring Agents)

Since a plurality of coloring agents is used in the present invention, they are, in this Specification, defined as follows in order to avoid confusion: a coloring agent that shields near infrared rays with wavelengths of 800 to 1,100 nm, emitted from a PDP, is called “a near infrared rays absorbing agent (also referred to as an NIR absorbing agent)”; a coloring agent for correcting the inherent emission spectrum of an insert gas (such as neon gas) characteristic of a PDP, that is, unwanted light with specific wavelengths, is called “a coloring agent for color tone correction (also referred to as a Ne light absorbing agent)”; and a coloring agent for adjusting the color tone of a displayed image to a favorite one is called “a coloring agent for color tone adjustment”. Collectively, these coloring agents are also referred to simply as “coloring agents”.

(Production of and Materials for Anti-Reflection Film for Plasma Display)

An anti-reflection film for plasma display of the present invention is produced in the following manner: (1) first, a transparent substrate film 31 is prepared, and the function of preventing reflection of light is imparted to one surface of this film (the outermost layer of a plasma display), or a transparent substrate film having the function of preventing reflection of light is prepared; (2) an unwanted light shielding layer 39 is formed on the transparent substrate film 31 surface on the side opposite to the surface having the function of preventing reflection of light; and (3) a pressure-sensitive adhesive layer 41 is formed on the above unwanted light shielding layer 39 surface, thereby obtaining an anti-reflection film for plasma display shown in FIG. 1.

A near infrared rays absorbing agent, a coloring agent for color tone correction and/or a coloring agent for color tone adjustment is incorporated in the above-described unwanted light shielding layer 39, near infrared rays absorbing layer 39A, specific-wavelength-light absorbing layer 39B, or unwanted light shielding layer 39D.

(1) In FIG. 1, the unwanted light shielding layer 39 contains a transparent synthetic resin (equivalent to a binder of a coating) in which a near infrared rays absorbing agent (NIR absorbing agent) and/or a coloring agent for color tone correction (typically, an agent for absorbing the emission spectrum of Ne atom) and, if necessary, a coloring agent for color tone adjustment are incorporated.

(2) In FIG. 2, the near infrared rays absorbing layer 39A contains a transparent synthetic resin to which a near infrared rays absorbing agent (NIR absorbing agent) is added. The specific-wavelength-light absorbing layer 39B, a layer provided separately from the near infrared rays absorbing layer, is made from a pressure-sensitive adhesive that contains a coloring agent for color tone correction (typically, an agent for absorbing the emission spectrum of Ne atom) and, if necessary, a coloring agent for color tone adjustment.

(3) In FIG. 3, the unwanted light shielding layer 39C is made from a pressure-sensitive adhesive that contains a near infrared rays absorbing agent (NIR absorbing agent) and/or a coloring agent for color tone correction (typically, an agent for absorbing the emission spectrum of Ne atom) and, if necessary, a coloring agent for color tone adjustment.

(4) In FIG. 2, a near infrared rays reflecting layer 39D made of a metallic film that reflects near infrared rays may be provided in place of the near infrared rays absorbing layer 39A.

Alternatively, the anti-reflection film shown in FIG. 2 may be modified as follows: a transparent synthetic resin in which a coloring agent for color tone correction has been incorporated is used to form the specific-wavelength-light absorbing layer 39B; a pressure-sensitive adhesive in which a near infrared rays absorbing agent has been incorporated is used to form the near infrared rays absorbing layer 39A; and the two layers 39A and 39B are laminated in the order reverse to the order shown in FIG. 2, that is, the specific-wavelength-light absorbing layer 39B is provided on the side of transparent substrate film 31, and the near infrared rays absorbing layer 39A is provided on the external side.

(Transparent Substrate Film)

The production process and materials to be used will be described hereinafter. A variety of materials can be used for the transparent substrate film 31 as long as they have transparency, insulating properties, heat resistance, mechanical strength, and so on that are high enough to withstand service conditions and production. Examples of materials useful herein include polyester resins such as polyethylene terephthalate and polyethylene naphthalate; polyamide resins such as nylon 6 and nylon 610; polyolefin resins such as polypropylene and polymethyl pentene; vinyl resins such as polyvinyl chloride; acrylic resins such as polymethyl (meth)acrylate; engineering resins such as polyallylate, polystyrene, polyphenylene ether, and polyaramide; styrene resins such as polystyrene; cellulose resins such as triacetyl cellulose (TAC); and polycarbonate.

The transparent substrate film 31 may also be made from a copolymer resin or mixture (including an alloy) whose main components are resins selected from the above-enumerated ones, or may be a laminate of a plurality of layers. Although the transparent substrate film may be either an oriented or non-oriented film, a mono- or bi-axially oriented film is preferably used to obtain improved strength. The thickness of the transparent substrate film 31 is usually about 12 to 1000 μm, preferably 50 to 700 μm, and most preferably 100 to 500 μm. A transparent substrate film 31 with a thickness of less than the above range cannot have sufficiently high mechanical strength and unfavorably curls and slacks, while a transparent substrate film 31 with a thickness of more than the above range has excessively high strength, which is wasteful also from the viewpoint of cost. With respect to the transparency of the transparent substrate film 31, the higher the better, and it is preferable that the transparent substrate film 31 has a visible light transmittance of not less than 80%. The transparent substrate film 31 may be a film, sheet, or board composed of at least one layer of any of the above-enumerated resins, and these forms are herein collectively referred to as films. In general, films of polyester resins such as polyethylene terephthalate and polyethylene naphthalate, and cellulose resins such as triacetyl cellulose (TAC) are conveniently used for the transparent substrate film 31 because they are excellent in both transparency and heat resistance and are inexpensive, and, of these, polyethylene terephthalate is most preferred.

Prior to coating, the coating surface of the transparent substrate film 31 may be subjected to adhesion-improving treatment such as corona discharge treatment, plasma treatment, ozone treatment, flame treatment, primer (also referred to as anchoring agent, adhesion-promoting agent, or adhesion-improving agent) coating treatment, preheating, dusting, vacuum deposition, or alkali treatment. Additives such as fillers, plasticizers, ultraviolet light absorbers, and antistatic agents may also be incorporated in the resin film, as needed.

An antistatic agent may be applied to the surface of the transparent substrate film 31 by a conventional method such as spray or roll coating. Alternatively, an antistatic agent blended with a binder may be applied to the surface of the transparent substrate film 31 by a conventional method such as spray or roll coating. Further, an antistatic agent may also be added to compositions for forming the other layers such as the anti-reflection layer 51 and the unwanted light shielding layer 39, thereby forming these layers containing the antistatic agent.

(Function of Preventing Reflection of Light)

In order to impart the function of preventing reflection of light to the surface of the above-described transparent substrate film 31, at least the anti-reflection layer 51 is provided on this surface. A commercially available transparent film having the function of preventing reflection of light, such as an anti-reflection film TAC-AR1 (trademark, manufactured by Dai Nippon Printing Co., Ltd., Japan), may be used as the anti-reflection layer. The function of preventing reflection of light means the function of reducing glaring and mirroring of surrounding objects that occur when extraneous light such as sunlight and light from fluorescent tubes is incident on the screen of a PDP and reflected from it. Further, by controlling the reflectance of the surface to low, image contrast can be made higher, and, as a result, image visibility is improved. In this Specification, the “anti-reflection layer” includes both an anti-reflection layer of multilayer film interference type (a so-called anti-reflection layer in a narrow sense) and a so-called anti-glaring layer of diffuse reflection type.

(Anti-Reflection Layer of Multilayer Film Interference Type)

In this Specification, an “anti-reflection layer of multilayer film interference type” denotes one or more transparent dielectric layers laminated to the surface of the transparent substrate film 31. The dielectric layers are constructed so that the outermost layer has a refractive index lower than that of a layer existing right under the outermost layer (the transparent substrate film or a dielectric layer existing right under the outermost dielectric layer, or, when the anti-reflection layer is laminated to a hard coat layer as will be described later, the hard coat layer), and the optical thickness (refractive index×geometrical thickness) of each dielectric layer is made ¼ of the wavelength of light whose reflection should be prevented. The anti-reflection layer of such a construction can, by interference, attenuate light reflected from the layer-layer interfaces. Typical examples of the layer construction of the anti-reflection layer include (1) the transparent substrate film/[a low refractive index layer], (2) the transparent substrate film/[a high refractive index layer/a low refractive index layer], (3) the transparent substrate film/[a low refractive index layer/a high refractive index layer/a low refractive index layer], and (4) the transparent substrate film/[a high refractive index layer/a medium refractive index layer/a low refractive index layer]. The parenthesized layers show the construction of the anti-reflection layer of multilayer film interference type. As for materials for the constituent layers of the anti-reflection layer of multilayer film interference type, materials for the low refractive index layer include inorganic materials such as magnesium fluoride (MgF₂) and rock crystal and low refractive index resin compositions that will be described later, and materials for the high refractive index layer include inorganic materials such as titanium dioxide and zinc sulfide. Examples of methods that can be used for forming the anti-reflection layer of multilayer film interference type include conventional dry coating methods such as vacuum deposition and sputtering, and conventional wet coating methods such as roll coating and lip die coating.

Specifically, it is possible to use as the anti-reflection layer (1) a laminate obtained by laminating, by vacuum deposition, a high refractive index layer with a refractive index of 2.3, made from zinc sulfide, and a low refractive index layer with a refractive index of 1.38, made from magnesium fluoride, in the order of (the transparent substrate film/[the high refractive index layer/the low refractive index layer/the high refractive index layer/the low refractive index layer]). The optical thickness of each layer is made ¼ of the D line (approx. 590 nm) of the atomic spectrum of sodium with a wavelength around the center of the visible light range.

It is also possible to use as the anti-reflection layer (2) a laminate obtained by laminating a low refractive index layer to the surface of the transparent substrate film by applying a low refractive index resin composition by lip die coating. The optical thickness of the low refractive index layer is made ¼ of the D line (approx. 590 nm) of the atomic spectrum of sodium with a wavelength around the center of the visible light range. A composition prepared by dispersing transparent fine particles with a mean particle diameter of 5 to 300 nm in an ionizing radiation curing resin that contains fluorine atom in its molecule can be used as the low refractive index resin composition. When ionizing radiation is applied to cross-link and cure the low refractive index resin composition that has been applied to the surface of the transparent substrate film, a large number of air-containing pores with a mean pore diameter of 0.01 to 100 nm are produced in the cured film and/or on the surface of the cured film, whereby a porous film is obtained.

Such an ionizing radiation curing resin containing fluorine atom in its molecule has a low refractive index as compared with ordinary resins, and a film of the resin is porous and contains air. Therefore, the mean refractive index of such a film approximates to the refractive index (1.0) of air, and, as a result, the film has a low refractive index.

The ionizing radiation curing resin containing fluorine atom in its molecule is a polymer with a number-average molecular weight of approximately 20,000 to 500,000, containing, in its molecule, an ionizing radiation curing functional group such as a radically polymerizable unsaturated group including (meth)acryloyl group or a cationically polymerizable functional group including epoxy group in addition to fluorine atom. (“(meth)acryloyl group” herein means “acryloyl group or methacryloyl group”.) Examples of the ionizing radiation curing resin containing fluorine atom in its molecule include homopolymers of monomers containing fluorine atom such as fluoroethylene, and copolymers of monomers containing fluorine atom and monomers containing no fluorine atom such as pentaerythritol triacrylate. The polymer may further contain a monomer having three or more ionizing radiation curing functional groups in one molecule, as needed. This monomer may contain or may not contain fluorine atom. Electron beam, ultraviolet light, or the like is typically used as the ionizing radiation.

Examples of the above-described fine particles include particles containing therein air, such as hollow particles and porous particles. Even particles containing therein no air, such as particles that form fine air bubbles around them when dispersed in the ionizing radiation curing resin, or (primary) particles that gather and agglomerate to involve air when dispersed in the ionizing radiation curing resin, may be used for the fine particles. Specific examples of the fine particles include hollow silica particles, porous silica particles, colloidal silica, and agglomerates of acrylic particles. The amount of the fine particles to be added is approximately 1 to 400 parts by weight for 100 parts by weight of the ionizing radiation curing resin containing fluorine atom in its molecule.

(Hard Coat Layer)

A hard coat layer that is optionally provided between the transparent substrate film 31 and the anti-reflection layer 51 is composed of a layer having a pencil hardness of H or more as determined by pencil hardness tests according to JIS K5400. The hard coat layer is formed by applying one of polyfunctional (meth)acrylate prepolymers such as polyester(meth)acrylate, urethane(meth)acrylate, and epoxy(meth)acrylate, or polyfunctional(meth)acrylate monomers such as trimethylol propane tri(meth)acrylate and dipentaerythritol hexa(meth)acrylate, or a mixture of two or more of these prepolymers and monomers, and curing the applied film in heat or ionizing radiation.

(Anti-Glaring Layer)

In this Specification, an “anti-glaring layer” means a layer that diffuses (scatters) light by fine irregularities present on its surface, or by fine particles with different refractive indexes dispersed in it, thereby preventing glaring and flickering of an image displayed. As for the optical properties of the anti-glaring layer, the haze value is 3% or more, preferably 3 to 40%, more preferably 5 to 30%. An anti-glaring layer having a haze value of less than 3% is poor in anti-glaring properties, while an anti-glaring layer having a haze value in excess of 40% is poor in light transmittance. The 60 degree specular gloss is 100 or less, preferably 90 or less, more preferably 50 to 85. An anti-glaring layer having a 60 degree specular gloss of more than 100 is poor in anti-glaring properties because of surface gloss brought about by reflection. The transmission visibility is 100 or more, preferably 150 or more, more preferably 200 to 300. When the transmission visibility is less than 100, the image visibility is not sufficiently high. The total light transmittance of the anti-glaring layer is 70% or more, preferably 75% or more, more preferably 80 to 95%. An anti-glaring layer having a total light transmittance of less than 70% is poor in transparency. The above-described ranges are satisfactory when the anti-glaring properties, image visibility, light transmittance, transparency, and so on are totally taken into consideration.

For the anti-glaring layer may be used conventional ones, preferably layers containing inorganic fillers such as silica, or layers having surfaces with fine irregularities that scatter extraneous light. An inorganic-filler-containing layer is formed in the following manner: silica particles with a mean particle diameter of usually 30 μm or less, preferably about 2 to 15 μm, are dispersed in a curing resin, for example, an acrylic resin such as a polyacrylate copolymer consisting of ethyl acrylate, butyl acrylate, 2-ethylhexyl acrylate, or t-butyl acrylate, a diene resin, a polyester resin, or a silicone resin, in an amount of approximately 0.1 to 10 parts by weight for 100 parts by weight of the resin; this dispersion is applied by gravure coating, reverse roll coating, die coating, or the like so that the dry film has a thickness of approximately 5 to 30 μm, and is dried; thereafter, heat, ultraviolet light, or electron beam is applied, as needed, to cure the film.

For the layer having a surface with fine irregularities can be used conventional ones such as a layer obtained by forming a resin layer by the use of a resin and a method that are used for forming the inorganic-filler-containing layer, and making irregularities on the resin layer by embossing; a layer obtained by applying a resin to a plate cylinder with irregularities, curing this resin in UV, and releasing the resin from the plate cylinder, thereby transferring the irregularities to the resin surface; or a layer obtained by applying a resin to a shaping film with irregularities, curing this resin in UV, and releasing the resin from the shaping film, thereby transferring the irregularities to the resin surface.

(Anti-Staining Layer)

An anti-staining layer may be provided on the surface of the anti-reflection layer 51. The anti-staining layer is usually a water- and oil-repellent coat, and siloxane compounds, fluorinated alkylsilyl compounds, and the like may be used for this layer. Fluoroplastics or silicone resins that are used as water-repellent coatings are herein suitably used. For example, in the case where the low refractive index layer in the anti-reflection layer is made from SiO₂, it is preferable to use a fluorosilicate water-repellent coating.

(Unwanted Light Shielding Layer)

An unwanted light shielding layer 39 is provided on the surface of the transparent substrate film 31 on the side opposite to the anti-reflection layer 51. The unwanted light shielding layer 39 contains a transparent synthetic resin and a near infrared rays absorbing agent and/or a coloring agent for color tone correction contained in the transparent synthetic resin. Any resin can be used as the transparent synthetic resin as long as it is transparent, and resins that may be used herein include conventional thermoplastic resins, thermosetting resins, reactive resins, electron beam (EB) curing resins, ultraviolet light (UV) curing resins, and mixtures of these resins. In the case where a thermosetting resin is used as the transparent synthetic resin, if a coloring agent that will be described later, especially a diimmonium compound, is incorporated, the coloring agent undergoes change in the course of hardening reaction with a hardening agent having a functional group such as isocyanate group and tends to lose its function. Further, in the case where an electron beam (EB) or ultraviolet light (UV) curing resin is used as the transparent synthetic resin, the coloring agent can undergo color change or fading, or lose its function when EB or UV is applied. For this reason, thermoplastic resins are preferred.

Thermoplastic resins useful herein include those resins that can serve as binders for supporting the coloring agent for color tone correction and the near infrared rays absorbing agent, and examples of such resins include vinyl chloride resins such as vinyl chloride-vinyl acetate copolymers, vinyl chloride-vinyl acetate-vinyl alcohol copolymers, and vinyl chloride-acrylonitrile copolymers; acrylic resins such as polymethyl(meth)acrylate, polybutyl(meth)acrylate, and (meth)acrylic ester-acrylonitrile copolymers; polyolefin resins such as cyclic polyolefins; styrene-acrylonitrile resins; polyvinyl butyral; polyester resins; polycarbonate resins; urethane resins; amide resins; cellulose resins (cellulose acetate butyrate, cellulose diacetate, cellulose triacetate, cellulose propionate, nitrocellulose, ethyl cellulose, methyl cellulose, propyl cellulose, methyl ethyl cellulose, carboxymethyl cellulose, acetyl cellulose, etc.); and mixtures of these resins. In this Specification, modified cellulose resins are also included in the synthetic resins. Acrylic resins, acrylonitrile resins, urethane resins, and polyester resins are preferred as the thermoplastic resins. These thermoplastic resins are advantageous in that they satisfactorily dissolve and stably preserve dyes that serve as the coloring agents, and that the dyes dissolved in these resins can maintain their functions.

The unwanted light shielding layer 39 is formed in the following manner: the transparent synthetic resin to which the desired additives such as a near infrared rays absorbing agent and a coloring agent for color tone correction have been added is dissolved in a solvent or the like, thereby obtaining a composition (ink) having a low viscosity, and this composition is applied and dried. In preparing the composition (ink), methyl ethyl ketone, ethyl acetate and/or toluene is used as the solvent in which the above-described resin is dispersed or dissolved. From the viewpoint of uniform dispersion, it is preferable to disperse or dissolve the coloring agents in a similar solvent separately from the transparent synthetic resin. A conventional printing or coating method such as screen printing, roll coating, reverse roll coating, slit reverse coating, spray coating, die coating, lip die coating, gravure coating (gravure printing), gravure reverse coating, or comma coating may be used to apply the composition.

(Pressure-Sensitive Adhesive)

In the present invention, a pressure-sensitive adhesive layer 41 is used only to fix the anti-reflection film for plasma display 30 to an adherend (FIG. 1). Instead of the above-described transparent resin, a pressure-sensitive adhesive 39B, 39C may be used as the binder of the near infrared rays absorbing agent and the coloring agent for color tone correction (FIGS. 2 and 3). In this case, the unwanted light shielding layer 39B, 39C itself serves also as a pressure-sensitive adhesive layer, as shown in FIGS. 2 and 3, so that the anti-reflection film can be fixed to an adherend without a pressure-sensitive adhesive layer separately formed. For the pressure-sensitive adhesive can be used conventional pressure-sensitive adhesives of any type. Examples of pressure-sensitive adhesives useful herein include natural rubber; synthetic rubber resins such as butyl rubber, polyisoprene, polyisobutylene, polychloroprene, and styrene-butadiene copolymer resins; silicone resins such as dimethyl polysiloxane; acrylic resins; vinyl acetate resins such as polyvinyl acetate and ethylene-vinyl acetate copolymers; urethane resins; acrylonitrile; hydrocarbon resins; alkylphenol resins; and rosin resins such as rosin, rosin triglyceride, and hydrogenated rosin.

The above-described resin serving as the pressure-sensitive adhesive, and a near infrared rays absorbing agent and a coloring agent for color tone correction that are optionally added are dissolved in a solvent or the like, thereby obtaining a composition (ink) having a low viscosity. This composition is applied and dried to form the pressure-sensitive layer or the unwanted light shielding layer. From the viewpoint of uniform dispersion, it is preferable to prepare the composition (ink) in the following manner: the above-described resin is dispersed or dissolved in a solvent such as methyl ethyl ketone, ethyl acetate and/or toluene; the coloring agents and so on are also separately dispersed or dissolved in a similar solvent; and these two dispersions or solutions are blended. A conventional printing or coating method such as screen printing, gravure printing, roll coating, die coating, gravure coating, or comma coating may be used for applying the composition.

(NIR Absorbing Agent)

Any agent can be used as the near infrared rays absorbing agent as long as it absorbs near infrared rays to such a practical extent that a layer containing the agent will have a transmittance of 20% or less, preferably 10% or less, for near infrared rays with wavelengths of 800 to 1100 nm. Examples of the near infrared rays absorbing agent useful herein include near infrared rays absorbing dyes that show sharp absorption on the border between the near infrared region and the visible light range and are highly transparent to light in the visible light range, such as polymethine dyes, cyanine compounds, phthalocyanine compounds, naphthalocyanine compounds, naphthoquinone compounds, anthraquinone compounds, dithiol metal complex compounds, immonium compounds, diimmonium compounds, and tungsten hexachloride.

(Coloring Agent for Color Tone Correction)

PDPs generate the inherent emission spectrum light (unwanted emission) of insert gases (e.g., neon, etc.) characteristic of PDPs to decrease the color purity of images. It is therefore necessary to provide a layer containing “a coloring agent for color tone correction (also referred to as a Ne light absorbing agent when the coloring agent is for absorbing the emission spectrum of neon (Ne) atom)” that absorbs the emission spectrum light and corrects the color purity. To absorb particularly the emission spectrum of neon (Ne) atom, a coloring agent for color tone correction that shows the maximum absorption at a wavelength of 570 to 605 nm is incorporated in the layer. Any conventional dye or pigment showing absorption at the desired wavelength in the visible light range can be used as the coloring agent for color tone correction. Useful herein are conventional organic dyes such as anthraquinone, phthalocyanine, methine, azomethine, oxazine, azo, styryl, coumarin, porphyrin, dibenzofuranone, diketopyrrolopyrrole, rhodamine, xanthene, and pyrromethene dyes.

(Coloring Agent for Color Tone Adjustment)

A coloring agent for color tone adjustment is used to improve transmission image contrast and to make color adjustment. Such a coloring agent absorbs visible light and is useful in varying the color tone of an image to adjust it to a favorite one. Examples of the coloring agent for color tone adjustment include organic or inorganic pigments such as monoazo pigments, quinacridone, thioindigo bordeaux, perylene maroon, aniline black, red oxide, chromium oxide, cobalt blue, ultramarine, and carbon black; and dyes such as indigoid dyes, carbonium dyes, quinoline dyes, nitroso dyes, naphthoquinone dyes, and perinone dyes. Coloring agents (dyes or pigments) that are preferably used herein are rhodamine, porphyrin, cyanine, squarilium, azomethine, xanthene, oxonol, and azo compounds that show the maximum absorption at a wavelength of 560 to 620 nm; cyanine compounds, merocyanine compounds, oxonol compounds, methine compounds such as arylidene or styryl compounds, anthraquinone compounds, quinone compounds, diphenylmethane dyes, triphenylmethane dyes, xanthene dyes, azo compounds, and azomethine compounds that absorb light in a wave range of 380 to 440 nm; and cyanine, squarilium, azomethine, xanthene, oxonol, azo, anthraquinone, triphenylmethane, xanthene, copper phthalocyanine, phenothiazine, and phenoxazine compounds that absorb light in a wave range of 640 to 780 nm. These coloring agents may be used either singly or as a mixture.

(Incorporation of Coloring Agents)

A manner in which at least one of the near infrared rays absorbing agent (NIR absorbing agent), the coloring agent for color tone correction (typically, a Ne light absorbing agent) and the coloring agent for color tone adjustment is incorporated in the unwanted light shielding layer 39 may be that an ink composition prepared by dissolving or dispersing, in a solvent, a composition and a coloring agent for the unwanted light shielding layer 39 is applied and dried. When forming the pressure-sensitive adhesive layer 41, release paper is, if necessary, laid over this layer, and pressure is applied with a roll or plate. To uniformly disperse the coloring agents, it is desirable to prepare the ink composition in the following manner: the coloring agents are dissolved or dispersed in a solvent in advance; the material for the unwanted light shielding layer is also separately dissolved or dispersed in a solvent in advance; and these two solutions or dispersions are blended or re-dispersed. Any method can be used for blending or dispersing the solutions or dispersions, and a conventional dispersion mixer such as a disper, mixer, tumbler, blender, homogenizer, or ball mill may be used.

The type and amounts of the coloring agents to be used may be properly selected depending on the absorption wavelengths and absorption coefficients of the coloring agents, the desired color tone, the transmittance required for the front panel for display, and so on. For example, the near infrared rays absorbing agent is incorporated in the layer in an amount of approximately 0.1 to 15% by weight of the layer, and the coloring agent for color tone correction or the coloring agent for color tone adjustment is incorporated in the layer in an amount of approximately 0.00001 to 2% by weight of the layer. In order to protect these coloring agents from ultraviolet light, a benzophenone or benzotriazole ultraviolet light absorber may be added to the layer. The amount of the ultraviolet light absorber to be added is approximately 0.1 to 10% by weight of the layer.

(Influence of Other Materials)

In the case where a diimmonium compound is used as the coloring agent, especially as the near infrared rays absorbing agent (NIR absorbing agent), its function tends to deteriorate for uncertain reasons in the course of hardening reaction of the adhesive or by the influence of strong polar groups. It is therefore desirable that a diimmonium compound be, as in the present invention, applied directly to the transparent substrate film 31 or the unwanted light shielding layer 39 that hardly impairs the function of the compound. It is also preferable to select, for the material for the unwanted light shielding layer 39 in which the coloring agents are incorporated, a material whose reactivity and polarity are as low as possible.

(Step Close to End)

In the present invention, the coloring agent for color tone adjustment is incorporated, as needed, in addition to the near infrared rays absorbing agent (NIR absorbing agent) and/or the coloring agent for color tone correction (typically, a Ne light absorbing agent). It is essential that the step of incorporating the coloring agent for color tone adjustment be effected at the point close to the end of the whole production process. In this step close to the end of the whole production process, it is possible to easily adjust the color tone of a displayed image according to customer's preference. Therefore, in the steps prior to the step of incorporating the coloring agent for color tone adjustment, it is possible to produce semi-finished products of one type in a large quantity according to one specification. The coloring agent for color tone adjustment that has been selected according to customer's preference is then incorporated in the semi-finished products in order to adjust the color tone of a displayed image. Thus, in the process of producing the anti-reflection film for plasma display, the decrease in productivity and the complication of process control can be minimized as a whole even when the step of adjusting color tone has to be effected in a small-quantity production of a variety of products. Consequently, reduction in cost can be attained.

(Near Infrared Rays Reflecting Layer)

In the present invention, in order to shield near infrared rays, a near infrared rays reflecting layer made of a film of a metal such as copper, gold, silver, or silver-palladium alloy may be used in place of the near infrared rays absorbing layer containing the near infrared rays absorbing agent (NIR absorbing agent). Alternatively, the metallic film may be used together with a semiconductor film such as indium tin oxide (ITO) or tin oxide film, where a plurality of the metallic films and the semiconductor films are alternately laminated. A laminate of the metallic films and the semiconductor films can shield not only near infrared rays but also electromagnetic waves (EMI). A laminate of approximately 3 to 11 layers of (ITO/silver or silver-palladium alloy) can also shield heat generated by a display. A thin metallic layer has low visible light transmittance, while a thick metallic layer has low reflectance for near infrared rays. It is therefore preferable that the thickness of one metallic film be 100 nm or less, and it is more preferable to alternately laminate the metallic films and the semiconductor films in order to obtain a metallic layer having an increased total thickness and a high visible light transmittance. Preferably, the thickness of one semiconductor film is 700 nm or less when electrical conductivity and transparency are taken into consideration. A conventional method such as sputtering, vacuum deposition, or ion plating may be used to form the above-described metallic or semiconductor film. The number of films that constitute the near infrared rays reflecting layer and/or the total thickness of the multiple films may be properly selected depending on near infrared rays shielding efficiency, transparency, transmittance, and/or reflectance.

(Ultraviolet Light Absorber)

In the anti-reflection film for a plasma display of the above-described construction, an ultraviolet light absorber is preferably incorporated in a layer (layers) selected from the transparent substrate film 31 and the layers provided on the transparent substrate film 31 on the side opposite to the unwanted light shielding layer 39 containing the near infrared rays absorbing agent, in order to prevent deterioration of the near infrared rays absorbing agent by ultraviolet light contained in extraneous light such as sunlight. By doing so, ultraviolet light contained in extraneous light is absorbed and reduced before it reaches (the unwanted light shielding layer containing) the near infrared rays absorbing agent. The layer (layers) in which an ultraviolet light absorber is incorporated is one layer, or two or more layers, selected from the transparent substrate film 31, the anti-reflection layer 51, and the other layers. Alternatively, a transparent resin layer containing an ultraviolet light absorber may be formed, separately from the above layers, in any position on the transparent substrate film 31 on the side opposite to the unwanted light shielding layer 39. For the ultraviolet light absorber is selected a transparent one, and examples of ultraviolet light absorbers useful herein include organic ultraviolet light absorbers such as benzotriazole compounds, benzophenone compounds, and triazine compounds, and inorganic ultraviolet light absorbers, such as zinc oxide and cerium oxide, in the form of fine particles with a particle diameter of approximately 0.2 μm or less. The amount of the ultraviolet light absorber to be added is approximately 0.1 to 5% by weight of each layer.

(Other Constituent Layers of Front Panel for Plasma Display)

The anti-reflection film for plasma display 30 of the present invention obtained above can easily form a front panel for plasma display 60 when combined with such a layer 61 as an electromagnetic wave shielding film or a transparent substrate (FIG. 1).

(Electromagnetic Wave Shielding Film)

Any film can be used for the above-described electromagnetic wave shielding film as long as it has the function of shielding electromagnetic waves. The electromagnetic wave shielding film may be a film containing a transparent conductive layer that is a metal layer in the form of meshes, a fibrous material coated with a metal, a film of a metal such as silver, or a multilayer film obtained by repeatedly laminating 1 to 7 times a semiconductor film—metallic film repeating unit.

(Transparent Substrate)

Any material can be used for the above-described transparent substrate as long as it has mechanical strength. Examples of materials useful herein include glass, polycarbonate resins, polyester resins, cellulose resins such as triacetyl cellulose and diacetyl cellulose, styrene resins, and acrylic resins such as polymethyl(meth)acrylate. Of these, glass and acrylic resins are preferred. From the viewpoint of the visibility of an image displayed on a display, it is preferable that the transparent substrate be transparent to visible light and has a mean transmittance of 50% or more for light with wavelengths of 450 to 650 nm. Further, coloring agents, ultraviolet light absorbers, antioxidants, antistatic agents, flame retarders, and the like may be optionally added to the transparent substrate unless they affect the functions of the transparent substrate. Although the transparent substrate can have any thickness, the thickness is usually about 1 to 10 mm, preferably 2 to 6 mm. A transparent substrate with a thickness of less than the above range is insufficient in mechanical strength. A transparent substrate with a thickness of more than the above range has excessive mechanical strength and is not practical because such a substrate is heavy.

(Production of Front Panel for Plasma Display)

A front panel for a plasma display can be obtained with ease from a laminate of (the anti-reflection film for plasma display of the present invention/the electromagnetic wave shielding film), (the anti-reflection film for plasma display/the electromagnetic wave shielding film/the substrate), or the like. The anti-reflection film for a plasma display and the electromagnetic wave shielding film, and the electromagnetic wave shielding film and the substrate may be superposed at a certain space or laminated by a pressure-sensitive adhesive or the like. In the case where a pressure-sensitive adhesive layer with release paper is present on one member, the release paper is peeled off, and the other member is stuck with pressure. Alternatively, a conventional method of lamination may be used; for example, an ink composition prepared by dissolving or dispersing a pressure-sensitive adhesive in a solvent is applied to one member and dried; the other member is superposed on this member; and pressure is applied by a roll or plate.

(Assembly of Plasma Display)

The above-described front panel for plasma display is mounted on the front of a PDP, thereby obtaining a plasma display. At this time, the front panel for plasma display is set so that the transparent substrate of the front panel faces to the PDP face. An air layer may be present between the front panel for plasma display and the PDP, or these two members may be directly attached to each other by an adhesive or the like.

### EXAMPLES

The present invention will now be explained more specifically by way of Examples and Comparative Examples. However, the present invention is not limited by these Examples.

### Example 1

An anti-reflection film TAC-AR1 (trademark, manufactured by Dai Nippon Printing Co., Ltd., Japan) produced by successively laminating a hard coat layer, a low refractive index layer, and an anti-staining layer to one surface of an 80-μm thick triacetyl cellulose (TAC) film as the substrate film 31 was prepared. The following unwanted-light-shielding-layer-forming composition was applied to the surface of the TAC film on the side opposite to the hard coat layer and was dried to form an unwanted light shielding layer.

The unwanted-light-shielding-layer-forming composition was prepared in the following manner: the following coloring agents were dispersed or dissolved in methyl ethyl ketone, and this dispersion or solution was mixed with a transparent acrylic resin; the viscosity of the mixture as measured by a zane cup No. 3 (manufactured by Rigo Kabushiki Kaisha, Japan) was then adjusted to 20 seconds. The coloring agents used were as follows: a diimmonium colorant CIR 1085 (trademark, manufactured by Japan Carlit, Co., Ltd., Japan), a phthalocyanine dye IR12 (trademark, manufactured by Nippon Shokubai Co., Ltd., Japan) and a phthalocyanine dye IR14 (trademark, manufactured by Nippon Shokubai Co., Ltd., Japan) as the near infrared rays absorbing agents (NIR absorbing agents); TAP-2 (trademark, manufactured by Yamada Chemical Co., Ltd., Japan) as the coloring agent for color tone correction (Ne light absorbing agent) ; and PS Violet RC (trademark, manufactured by Mitsui Toatsu Dyes, Ltd., Japan) as the coloring agent for color tone adjustment.

An acrylic resin composition was applied to the surface of the unwanted light shielding layer and was dried, thereby forming a pressure-sensitive adhesive layer. Release paper, a 100-μm thick PET film coated with silicone, was laid over this pressure-sensitive adhesive layer.

### Example 2

An anti-reflection film for a plasma display was obtained in the same manner as in Example 1, except that, of the coloring agents, only the near infrared rays absorbing agents (NIR absorbing agents) and the coloring agent for color tone correction (Ne light absorbing agent) were incorporated in the unwanted-light-shielding-layer-forming composition.

### Example 3

An anti-reflection film for a plasma display was obtained in the same manner as in Example 1, except that, of the coloring agents, only the near infrared rays absorbing agents (NIR absorbing agents) were incorporated in the unwanted-light-shielding-layer-forming composition.

### Example 4

An anti-reflection film for a plasma display was obtained in the same manner as in Example 1, except that the pressure-sensitive adhesive layer was not provided and that no release paper was used.

### Example 5

An anti-reflection film for a plasma display was obtained in the same manner as in Example 2, except that the pressure-sensitive adhesive layer was not provided and that no release paper was used.

### Example 6

An anti-reflection film for plasma display was obtained in the same manner as in Example 4, except that a biaxially oriented PET film with a thickness of 75 μm was used as the substrate film 31, and that the unwanted light shielding layer was made from two layers, a near infrared rays absorbing layer formed by the use of the unwanted-light-shielding-layer-forming composition in which only the near infrared rays absorbing agents (NIR absorbing agents) were incorporated as the coloring agents, and an unwanted light shielding layer serving also as a pressure-sensitive adhesive layer, formed by the use of the pressure-sensitive-adhesive-layer-forming composition to which the coloring agent for color tone correction (Ne light absorbing agent) was added.

### Example 7

An anti-reflection film for a plasma display was obtained in the same manner as in Example 4, except that a biaxially oriented PET film with a thickness of 75 μm was used as the substrate film 31, and that the unwanted light shielding layer was made from two layers, a near infrared rays absorbing layer formed by the use of the unwanted-light-shielding-layer-forming composition in which only the near infrared rays absorbing agents (NIR absorbing agents) were incorporated as the coloring agents, and an unwanted light shielding layer serving also as a pressure-sensitive adhesive layer, formed by the use of the pressure-sensitive-adhesive-layer-forming composition to which the coloring agent for color tone correction (Ne light absorbing agent) and the coloring agent for color tone adjustment were added.

### Example 8

An anti-reflection film for a plasma display was obtained in the same manner as in Example 4, except that a biaxially oriented PET film with a thickness of 75 μm was used as the substrate film 31, that, of the coloring agents, only the coloring agent for color tone correction (Ne light absorbing agent) was incorporated in the unwanted-light-shielding-layer-forming composition, and that a near infrared rays absorbing layer was formed by the use of the pressure-sensitive-adhesive-layer-forming composition to which the near infrared rays absorbing agents (NIR absorbing agents) were added.

### Example 9

An anti-reflection film for a plasma display was obtained in the same manner as in Example 4, except that a biaxially oriented PET film with a thickness of 75 μm was used as the substrate film 31, and that the unwanted light shielding layer was formed by the use of the pressure-sensitive-adhesive-layer-forming composition to which the near infrared rays absorbing agents (NIR absorbing agents), the coloring agent for color tone correction (Ne light absorbing agent), and the coloring agent for color tone adjustment were added.

### Example 10

An anti-reflection film for a plasma display was obtained in the same manner as in Example 4, except that a biaxially oriented PET film with a thickness of 75 μm was used as the substrate film 31, and that the unwanted light shielding layer was formed by the use of the pressure-sensitive-adhesive-layer-forming composition to which the near infrared rays absorbing agents (NIR absorbing agents) and the coloring agent for color tone correction (Ne light absorbing agent) were added.

### Example 11

An anti-reflection film for a plasma display was obtained in the same manner as in Example 1, except that a biaxially oriented film with a total thickness of 100 μm, composed of a two-layered laminate of an 80-μm thick polyethylene terephthalate layer containing, as an ultraviolet light absorber, 1% by weight of 2(4,6-diphenyl-1,3,5-triazine-2-yl)-5-[(hexyl)oxy]-phenol and a polyethylene terephthalate layer with a thickness of 20 μm, containing no ultraviolet light absorber, was used as the transparent substrate film, and that the unwanted light shielding layer was formed on the layer containing no ultraviolet light absorber, contained in the transparent substrate film.

### Example 12

An anti-reflection film for plasma display was obtained in the same manner as in Example 11, except that a 38-μm thick PET (polyethylene terephthalate) film was used instead of the TAC film in the anti-reflection film.

### Example 13

A 15-nm thick silver film, a 50-nm thick ITO film, a 15-nm thick silver film, a 50-nm thick ITO film, a 15-nm thick silver film, and a 50-nm thick ITO film were successively laminated in this order to one surface of a TAC film with a thickness of 80 μm by vacuum deposition, thereby obtaining a near infrared rays reflecting layer composed of metallic films. To the other surface of the TAC film were laminated a hard coat layer, an anti-reflection layer made of a low refractive index layer, and an anti-staining layer (according to the same specification as that of the previously-mentioned anti-reflection film TAC-AR1 (trademark, manufactured by Dai Nippon Printing Co., Ltd., Japan)).

To the surface of the above ITO film, the following composition was applied and dried, thereby forming an unwanted light shielding layer serving also as a pressure-sensitive adhesive layer. To this layer was laminated release paper, a 100-μm thick PET film coated with silicone.

The composition used for forming the unwanted light shielding layer was prepared by adding, to an acrylic resin pressure-sensitive adhesive, the coloring agent for color tone correction (Ne light absorbing agent) and the color agent for color tone adjustment, those coloring agents used in Example 1.

Presence or absence of the coloring agents in the anti-reflection films of Examples 1 to 10 is shown in Tables 1 and 2.

TABLE 1

| Item | | Example 1 | Example 2 | Example 3 | Example 4 | Example 5 |
|---|---|---|---|---|---|---|
| Anti-reflection layer | | present | present | present | present | present |
| Substrate film | | TAC | TAC | TAC | TAC | TAC |
| Unwanted light | presence or absence of | one layer | one layer | one layer | one layer | one layer |
| shielding layer | layer | | | | | |
| | for absorbing NIR | present | present | present | present | present |
| | for absorbing Ne light | present | present | absent | present | present |
| | for adjusting color tone | present | absent | absent | present | absent |
| Pressure-Sensitive | presence or absence | present | present | present | absent | absent |
| Adhesive layer | of layer | | | | | |

TABLE 2

| Item | | Example 6 | Example 7 | Example 8 | Example 9 | Example 10 |
|---|---|---|---|---|---|---|
| Anti-reflection layer | | present | present | present | present | present |
| Substrate film | | PET | PET | PET | PET | PET |
| Unwanted light | presence or absence of | two layers | two layers | two layers | two layers | two layers |
| shielding layer | layer | | | | | |
| | for absorbing NIR | present | present | present | present | present |
| | for absorbing Ne light | present | present | present | present | present |
| | for adjusting color tone | absent | present | absent | present | absent |
| Pressure-Sensitive | Presence or absence | Pressure or | Serving also as | Serving also as | Serving also as | Serving also as |
| Adhesive layer | of layer | absence of layer | unwanted light | unwanted light | unwanted light | unwanted light |
| | | | shielding layer | shielding layer | shielding layer | shielding layer |

(Method of Evaluation)

The anti-reflection film for a plasma display of each Example was assembled into a front panel for a plasma display and then into a plasma display in the following manner, and a TV test pattern, a white-colored solid image, and a black-colored solid image that were displayed on the display were visually observed to evaluate color tone and image visibility. The release paper on each one of the anti-reflection films for plasma display of Examples 1 to 3, 6 to 10, 11 and 12 was removed. DNP-EMI (trademark of an electromagnetic wave shielding film, manufactured by Dai Nippon Printing Co., Ltd., Japan) was then laminated to each anti-reflection film, and a glass plate (substrate) with a thickness of 3 mm was further laminated by a pressure-sensitive adhesive, thereby obtaining a front panel for plasma display. This front panel was mounted on a PDP “WOOO” (trademark, manufactured by Hitachi, Ltd., Japan) through a 5-mm thick air layer, whereby a plasma display was obtained. To each of the anti-reflection films for a plasma display of Examples 4 and 5, DNP-EMI (trademark of an electromagnetic wave shielding film, manufactured by Dai Nippon Printing Co., Ltd., Japan) was laminated by a pressure-sensitive adhesive, and an acrylic plate (substrate) with a thickness of 3 mm was further laminated by a pressure-sensitive adhesive, thereby obtaining a front panel for plasma display. Each front panel was fixed directly to the front of a PDP “WOOO” (trademark, manufactured by Hitachi, Ltd., Japan) by the use of a pressure-sensitive adhesive, whereby a plasma display was obtained. To the anti-reflection film for plasma display of Example 13, having the function of shielding electromagnetic waves, an acrylic plate (substrate) with a thickness of 3 mm was laminated by a pressure-sensitive adhesive, thereby obtaining a front panel for plasma display. This front panel was fixed directly to the front of a PDP “WOOO” (trademark, manufactured by Hitachi, Ltd., Japan) by the use of a pressure-sensitive adhesive, whereby a plasma display was obtained.

(Evaluation)

In the observations of the TV test pattern, the white-colored solid image, and the black-colored solid image, all of the plasma displays provided with the anti-reflection films of Examples 1 to 13 were found to be normal in terms of color tone reproduction, caused neither glaring nor significant mirroring of extraneous light, and excellently displayed images. The rates of attenuation of electromagnetic waves were 30 to 60 dB at 30 to 1000 MHz, and transmittances for the near infrared rays with wavelengths of 800 to 1100 nm were 4 to 10%.

1. An anti-reflection film for a plasma display, comprising:
a transparent substrate film,
an anti-reflection layer provided on one surface of the transparent substrate film, and
an unwanted light shielding layer provided on the other surface of the transparent substrate film,
the unwanted light shielding layer containing a transparent resin and a coloring agent for color tone correction that absorbs light with specific wavelengths originating from the emission spectrum of an insert gas of a plasma display and/or a near infrared rays absorbing agent that absorbs near infrared rays, contained in the transparent resin.

2. The anti-reflection film for a plasma display according to claim 1, wherein
the transparent resin contains a coloring agent for color tone adjustment.

3. The anti-reflection film for a plasma display according to claim 1, further comprising:
an adhesive layer that is laminated to the unwanted light shielding layer.

4. An anti-reflection film for a plasma display, comprising:
a transparent substrate film,
an anti-reflection layer provided on one surface of the transparent substrate film, and
an unwanted light shielding layer provided on the other surface of the transparent substrate film,
the unwanted light shielding layer comprising:
a near infrared rays absorbing layer containing a transparent resin and a near infrared rays absorbing agent that absorbs near infrared rays, contained in the transparent resin, and
a specific-wavelength-light absorbing layer laminated to the near infrared rays absorbing layer on the side opposite to the transparent substrate film, containing an adhesive and a coloring agent for color tone correction that absorbs light with specific wavelengths originating from the emission spectrum of an insert gas of a plasma display, contained in the adhesive.

5. The anti-reflection film for a plasma display according to claim 4, wherein
the adhesive contains a coloring agent for color tone adjustment.

6. An anti-reflection film for a plasma display, comprising:
a transparent substrate film,
an anti-reflection layer provided on one surface of the transparent substrate film, and
an unwanted light shielding layer provided on the other surface of the transparent substrate film,
the unwanted light shielding layer comprising:
a near infrared rays reflecting layer made of a metallic film that reflects near infrared rays, and
a specific-wavelength-light absorbing layer laminated to the near infrared rays reflecting layer on the side opposite to the transparent substrate film, containing an adhesive and a coloring agent for color tone correction that absorbs light with specific wavelengths originating from the emission spectrum of an insert gas of a plasma display, contained in the adhesive.

7. The anti-reflection film for a plasma display according to claim 6, wherein
the adhesive contains a coloring agent for color tone adjustment.

8. An anti-reflection film for a plasma display, comprising:
a transparent substrate film,
an anti-reflection layer provided on one surface of the transparent substrate film, and
an unwanted light shielding layer provided on the other surface of the transparent substrate film,
the unwanted light shielding layer containing an adhesive and a coloring agent for color tone correction that absorbs light with specific wavelengths originating from the emission spectrum of an insert gas of a plasma display and/or a near infrared rays absorbing agent that absorbs near infrared rays, contained in the adhesive.

9. The anti-reflection film for a plasma display according to claim 8, wherein
the pressure-sensitive adhesive contains a coloring agent for color tone adjustment.

10. An anti-reflection film for a plasma display, comprising:
a transparent substrate film,
an anti-reflection layer provided on one surface of the transparent substrate film, and
an unwanted light shielding layer provided on the other surface of the transparent substrate film,
the unwanted light shielding layer comprising:
a specific-wavelength-light absorbing layer containing a transparent resin and a coloring agent for color tone correction that absorbs light with specific wavelengths originating from the emission spectrum of an insert gas of a plasma display, contained in the transparent resin, and
a near infrared rays absorbing layer laminated to the specific-wavelength-light absorbing layer on the side opposite to the transparent substrate film, containing an adhesive and a near infrared rays absorbing agent that absorbs near infrared rays, contained in the pressure-sensitive adhesive.

11. The anti-reflection film for a plasma display according to claim 10, wherein
the transparent resin contains a coloring agent for color tone adjustment.

12. The anti-reflection film for a plasma display according to claim 1, wherein
at least one layer selected from the transparent substrate film and the layers provided on the transparent substrate film on the side opposite to the unwanted light shielding layer contains an ultraviolet light absorber.
